(19) United States
(12) Patent Application Publication
(10) Pub. No.: US 2018/0129679 A1
(43) Pub. Date: May 10, 2018

(54) DATA VOLUME MANAGER

(71) Applicant: OPEN INVENTION NETWORK LLC, DURHAM, NC (US)

(72) Inventor: Robert Yao, Farmingdale, NY (US)

(21) Appl. No.: 15/806,080

(22) Filed: Nov. 7, 2017

Related U.S. Application Data
(60) Provisional application No. 62/418,605, filed on Nov. 7, 2016.

(51) Int. Cl. G06F 17/30

(52) U.S. Cl. CPC G06F 17/30174; G06F 17/30076; G06F 17/30144; G06F 17/30088

(57) ABSTRACT

A system comprises one or more computer hosts each comprising one or more Central Processing Units, one or more file systems, a host operating system, and one or more memory locations, wherein said CPUs are operatively connected to said one or more memory locations and configured to perform one or more of: execute one or more software on a host OS, wherein said software is configured to create one or more snapshots of said one or more file systems, identify one of said snapshots as an originator snapshot, identify a second snapshot, determine differences between said second snapshot and said originator snapshot, determine one or more file system calls transforming said originator snapshot into said second snapshot based on said differences and store said one or more file system calls that transform said originator snapshot into said second snapshot in one or more of non-transitory storage and transitory storage.

### CROSS-REFERENCE TO RELATED APPLICATIONS

The present application is related to, and claims priority from, provisional patent application 62/418,605, titled Delta Algorithm, filed 7 Nov. 2016, the entire contents of which are incorporated by reference herein.

The present application is also related to PCT/EP2015/078730 (WO 2016/087666), the entire contents of which are incorporated by reference herein.

### BACKGROUND

The present description relates to managing data volumes in an application independent manner, addressing this by providing a service for managing and transporting data as data volumes, and a method which enables replication of file system snapshots in a manner that is snapshot technology independent.

Container Image (CI) formats and accompanying infrastructure such as Docker and Docker Registry have revolutionised application development by creating efficient and portable packaging and easy to use mechanisms for storing and retrieving these images. However, these images do not include or reference the persistent data that most applications must work with.

Current restrictions that exist with container image formats include the inability of running multiple tests against the same data in parallel, the cost of loading data onto multiple machines to parallelise it, a requirement to reset the “golden” volume when a test is over and the challenging nature of debugging build failures. It is very unsatisfactory for engineers to use production software to fix a bug.

### SUMMARY

According to the following description, a new technology is offered which allows a snapshot of a production database to be taken and stored in a volume hub. One or more person may have access to the snapshot depending on the authorisations and access rights. Different people can have different accesses to different versions of the snapshot, where a version of the snapshot can be considered to be the snapshot plus a “delta” where the delta represents the difference between the original snapshot and the new version.

The new technology discussed herein also presents a relationship between a volume manager, which can be considered a data producer and consumer, and a volume hub which provides storage for metadata and data. This relationship is discussed further in our earlier patent application WO 2016/087666, the contents of which are herein incorporated by reference.

In one embodiment, a system comprises one or more computer hosts each comprising one or more Central Processing Units, one or more file systems, a host operating system, and one or more memory locations, wherein said Central Processing Units are operatively connected to said one or more memory locations and configured to perform one or more of: execute one or more software on a host operating system, wherein said software is configured to create one or more snapshots of said one or more file systems, identify one of said snapshots as an originator snapshot, identify a second snapshot, and determine differences between said second snapshot and said originator snapshot, determine one or more file system calls transforming said originator snapshot into said second snapshot based on said differences between said second snapshot and said originator snapshot and store said one or more file system calls that transform said originator snapshot into said second snapshot in one or more of non-transitory storage and transitory storage.

For a better understanding of the present application and to show how the same may be carried into effect, reference will now be made to the accompanying drawings.

### BRIEF DESCRIPTION OF THE DRAWINGS

FIG. 1 is a highly schematized diagram of a file system;

FIG. 2 is a schematic block diagram of an application life cycle implemented using a volume hub;

FIG. 2a is a schematic diagram of snapshot versions of a file history;

FIG. 3 is a schematic functional diagram of a delta algorithm;

FIG. 4 is a flow chart illustrating the steps taken by a delta algorithm;

FIG. 5 is a schematic block diagram of state machines;

FIGS. 6a and 6b show the steps in a use case of the volume hub; and

FIG. 7 is a schematic block diagram showing the use of a volume hub in a container data management architecture.

### DETAILED DESCRIPTION

The following description relates to a service (volume hub) which provides a secure and efficient solution to managing and transporting data as data-volumes in an application independent manner and to an algorithm referred to herein as “the delta algorithm” which enables replication of POSIX file system snapshots in a manner that is snapshot-technology-independent. This means that the replication of snapshots on a file system of a first technology (e.g. ZFS) to a file system of a second technology (for example, XFS on LVM) would be possible. This is achieved by having a sender, which has both copies of file system snapshots—S1 and S2, use the delta algorithm to calculate the file system calls required to transform a first one of the snapshots S1 into a second one of the snapshots S2. These file system calls are then sent (in the form of instructions) to a receiving end which only has access to the first snapshot S1 and are executed there to transform the first snapshot S1 to the second snapshot S2. The delta algorithm and the volume hub may be used together or separately.

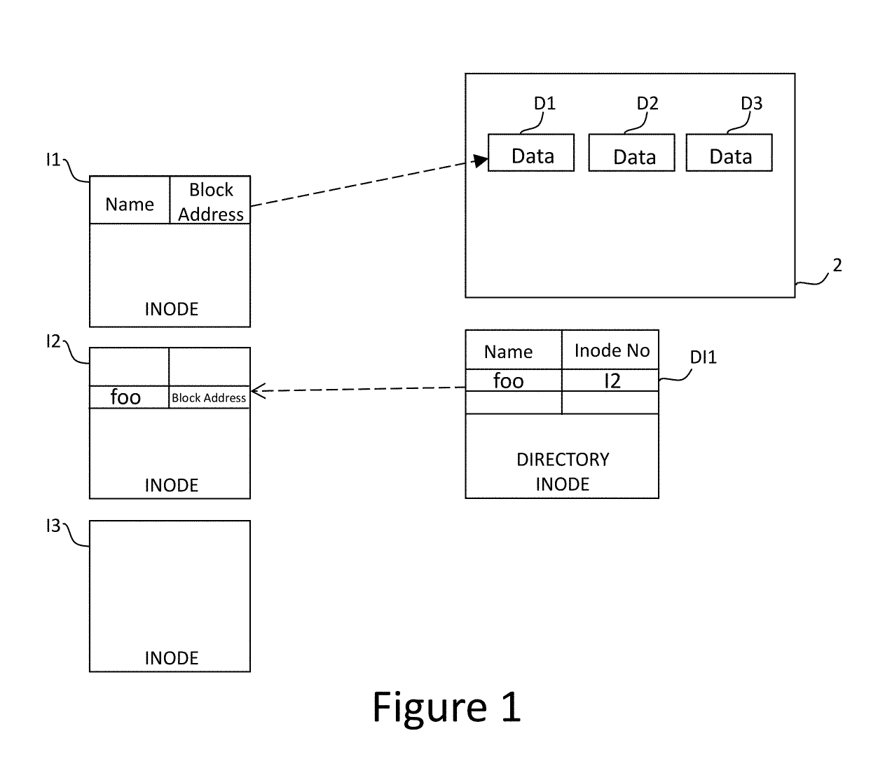

Before describing the embodiments of the present application, a description is given of the basic layout of an exemplary file system. In the description of embodiments of the application which follow, various terms are utilised, and the definitions of these terms are explained below in the context of the explanation of an exemplary file system. In a file system, the file data is stored at memory locations, for example disk block locations. Exemplary data blocks D1, D2, D3 are shown in memory 2. Of course, in practice there will be a very large number of such blocks. An inode structure is used to access file data. An inode is a data structure which is used to represent a file system object, which can be of different kinds, for example a file itself or a directory. An inode stores attributes (e.g. name) and memory locations (e.g. block addresses) of the file data. An inode has an inode number. Inodes I1, I2 and I3 are shown in FIG. 1. In a file system, file data is stored distinctly from its name and can be referenced by more than one name. Each file name, called a link, points to the actual data of the file itself. An inode provides a map between a file name and the addresses of the memory locations where data of that file is held.

The name of an item and its inode number are stored in a directory. Directory storage for that name and inode number can itself be in the form of an inode, which is referred to herein as a directory inode DI1. A link is a directory entry in which a file name points to an inode number and type. For example, the file foo in directory inode D1l points to inode 12. Inode 12 holds the name ‘foo’ and block addresses and data in the file name ‘foo’. This type of link can be considered to be a hard link. Other types of link exist in a file system which are referred to as “symlinks”. A symlink is any file that contains a reference to another file or directory in the form of a specified path. Inodes referred to in the directory inodes may themselves be directory inodes, normal file inodes or any other type of inode. Similarly, entries in “normal” inodes can refer to directory inodes.

The inodes themselves are data structures which are held in memory. They are held in file system memory which normally will be a memory separate from the block device memory in which the data itself is actually held. However, there are combined systems and also systems which make use of a logical volume mapping in between the file system and the physical data storage itself. There are also systems in which the inodes themselves are held as data objects within memory.

As already noted, FIG. 1 is a schematic illustration of one type of file system. There are many different kinds of file systems which have been developed, and one of the advantages of the embodiments of the application described below is that it enables replication of file system snapshots in a manner that is snapshot technology independent. A snapshot is a read only copy of a file system or volume at a point in time. They are sometimes referred to as “images”. The words “snapshot” and “image” may be used interchangeably herein to denote a point in time read only copy of a file system or data volume.

One known file system is ZFS, which is a combined file system and logical volume manager developed by Sun. Another file system is XSF which is a high performance 64-bit journaling file system which can operate with a logical volume manager LVM. A logical volume manager is a device that provides logical volume management where logical volumes are mapped to physical storage volumes.

Volume Hub

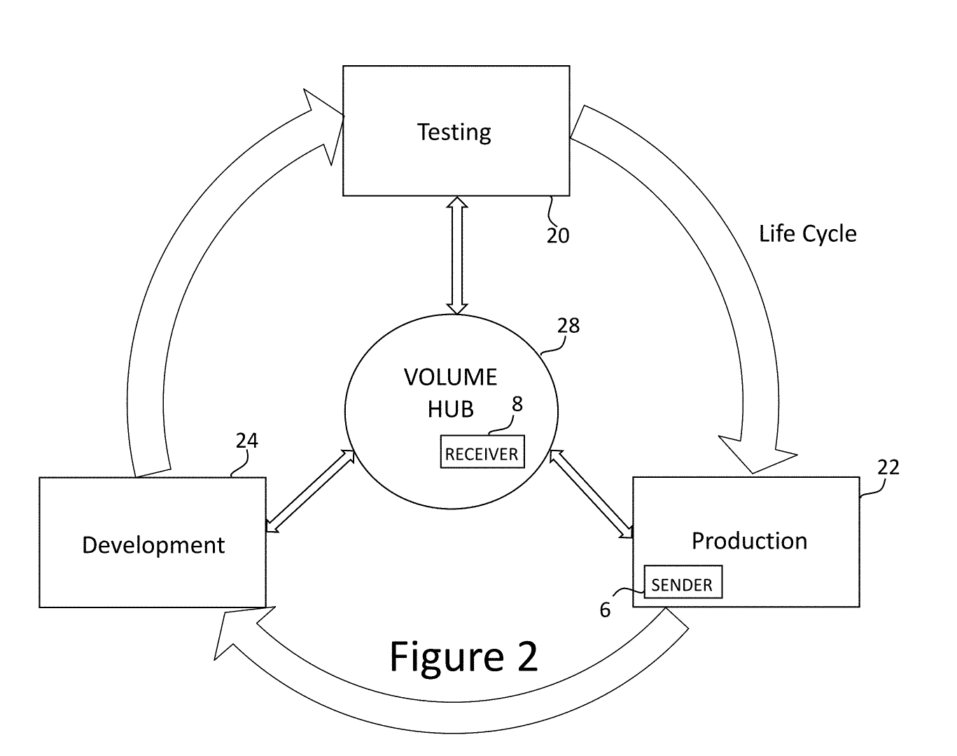

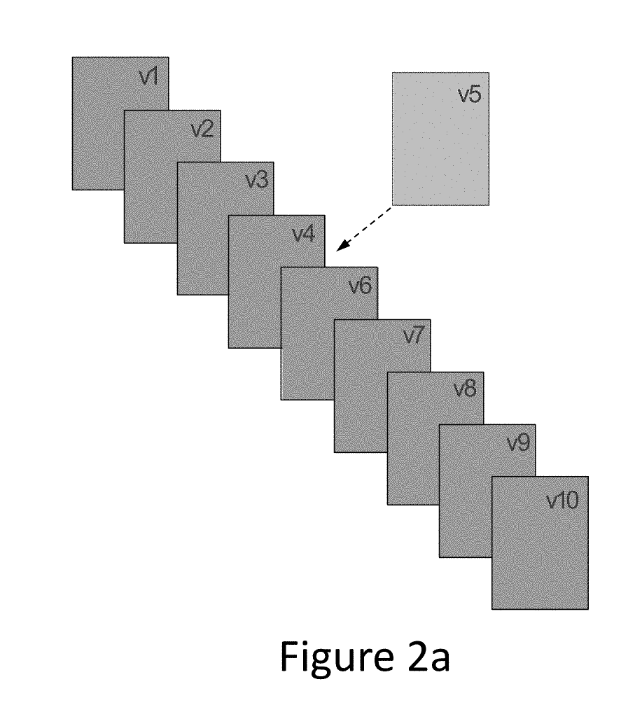

Data lives at all stages of an application life cycle. See FIG. 2 which is a schematic diagram of an application life cycle. This includes a staging or production environment 20 which enables CI/CD system integrations. The staging/testing environment needs real production data and has to satisfy data security issues.

A production environment 22 provides availability of the application, including cloud portability where relevant. Management of several databases may be needed in the production environment. Production environment may provide heterogeneous data stores. The development environment 24 should ideally enable complex data code integrations and data sharing across a team.

A computer entity is provided in accordance with embodiments of the application which is referred to herein as the volume hub 26. This volume hub provides container data management across the entire flow in the application life cycle. Thus, the volume hub 26 is in communication with each of the staging environment 20, production environment 22 and development environment 24.

There is an existing technology which enables centralized storage and access for source code. This is known as GitHub technology. This technology does not however allow a shared repository of data stores. The term used herein “git-for-data” is shorthand way of indicating the advantages offered by embodiments of the present application which enable a shared repository of data stores with historical versioning and branching, etc. In the “git-for-data” service, each volume becomes a volume set, a collection of snapshots that tell the entire volume's history in space and time. Each snapshot is associated with a particular point in the volumes history. For example, a snapshot at a time of build failure, associated with a bug report on a particular day, can speed debugging dramatically. Central snapshot storage allows any machine (in any of the different environments 20, 22, 24) to access data. Access controls can be implemented to allow different levels of access. FIG. 2a is a highly schematized diagram showing ten different snapshots of a particular data volume, the snapshots labelled V1 to V10. The snapshot V5 represents the required snapshot at the time of build failure and can be accessed separately by any of the environments.

Use cases for the volume hub include: easier debugging of build failures, on demand staging environments and integration tests against real data.

FIG. 2 illustrates a context in which it is useful to enable replication of file system snapshots in a manner that is snapshot-technology-independent. This is achieved in the following by a delta algorithm, described later. The delta algorithm is suitable for POSIX (portable operating system interface) file systems, but the underlying concept could be extended to other standards for application programming interfaces (APIs).

FIG. 2 shows a sender and a receiver. The sender and the receiver can be any kind of computer machines or computer devices. Some use cases are discussed later. The sender and the receiver are each equipped with one or more processors capable of executing computer programs to implement the functionality which is described herein. The functionality is described in terms of functional blocks. In one embodiment, the sender and receiver could be the same computer device or machine. However, in the described embodiment, it is assumed that the sender is operating in one environment (for example, a software production environment), and the receiver is operating in a volume hub in communication with different environments (e.g. testing and development) via any suitable communication network or pathway. Different use cases will be described below in connection with the volume hub, but one possibility is shown in FIG. 2 where the sender device 6 is located in the production environment and has caused two snapshots S1, S2 to be created. The receiver device 8 is at the volume hub and this has access to the snapshot S1, because that was previously sent to the volume hub. However, it does not have snapshot S2.

Note that the ‘sender’ and ‘receiver’ could be located in any part of the applications life cycle, including in the same environment, or at the volume hub.

Delta Algorithm

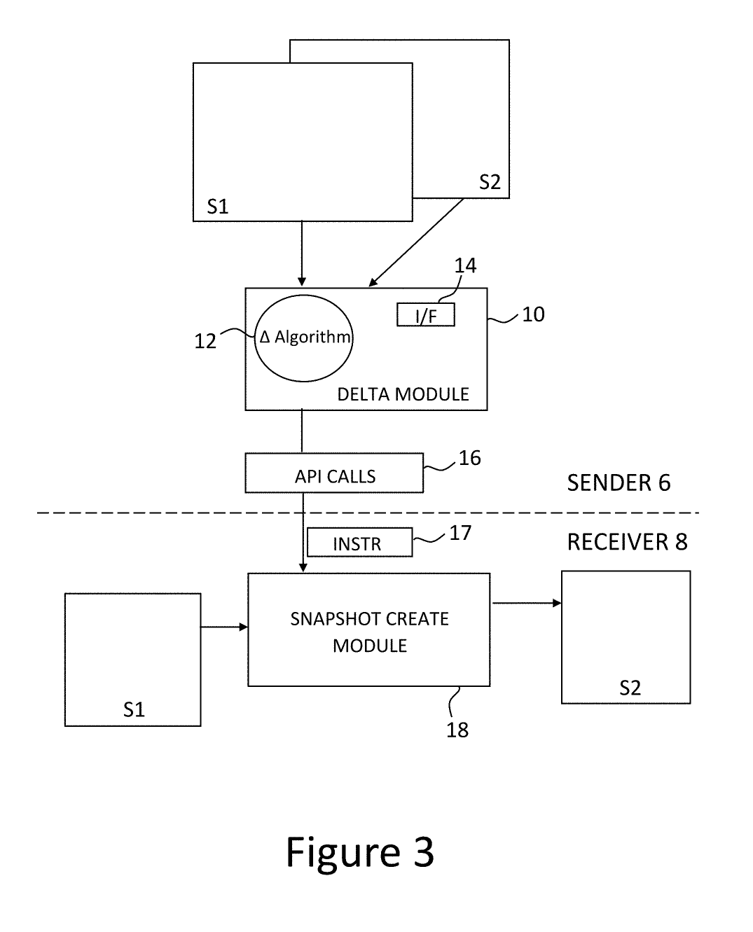

Reference will now be made to FIG. 3 which shows using functional blocks the operations at the send and receive sides. A transverse broken line denotes a separation between the send side 6 and the receive side 8. At the send side 6, two snapshots S1, S2 have been created. They are supplied to a delta algorithm module 10 which implements the delta algorithm 12. The delta algorithm 12 can be called into operation by an interface 14, for example written in the Go language. The delta algorithm 12 takes in the file system snapshots S1 and S2 and calculates the POSIX file API calls 16 to transform S1 snapshot into S2. The API calls generate instructions which are sent in a message 17 from the sender 6 to the receiver 8 via any suitable communication network or pathway. The receiver 8 has a snapshot create module which applies the instructions 17 to its own copy of snapshot S1, which it had already been provided with. As a result of applying the instructions to the snapshot S1, the snapshot S2 is created at the receiver 8. The snapshot create module comprises a suitable processor which is capable of executing the instructions derived from the POSIX file API calls and extracted from the message 17. Note that the snapshot S1 could be sent with the message 17, if the receiver did not already have it.

Operation of the algorithm is described below. It is noted that although in principle two different file names could refer to the same inode, the embodiment of the algorithm discussed herein makes the assumption that any link to an inode that has the same inode number and inode type in snapshot S1 and snapshot S2 is the same file. If the snapshot S2 is the successor of the snapshot S1, this is true for most existing file systems, and in particular is true for the XFS, LVM+ext4, btrfs. Even though that is not the case when the inode number is re-used, it is possible to transform any regular file into any other regular file via system calls. In the case of other file types, an unlink can be done and recreated. In the case where the same inode number with a different type is seen on S1 and S2, the algorithm is premised on the fact that that inode was unlinked.

The algorithm comprises a front end and a backend, for example as in a compiler. The front end is responsible for transversal/parsing and the backend is responsible for output generation. Alternatively, these could be done at once (without a front end/backend structure), and the application is not limited to any particular implementation of the features discussed in the following.

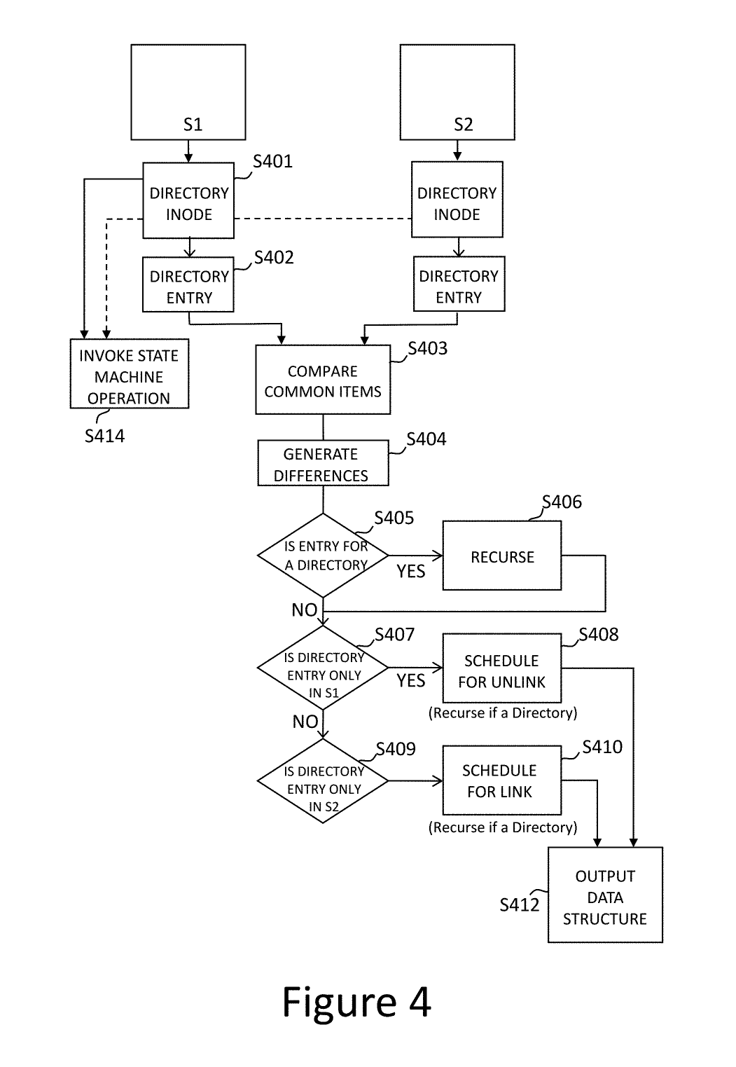

FIG. 4 is a schematic flow chart illustrating operation of the delta algorithm. The algorithm traverses the two snapshots S1 and S2 in lockstep. At step S401, any directories in common are identified during the traverse, and for each directory in common the algorithm sorts and operates on each directory entry (S402) as if it were doing a merge operation in merge sort. The comparator for the sort puts directories first. Each item that is common is “diffed”, that is a side-by-side comparison is made (S403) and differences are identified (S404). As already mentioned, a directory can include entries for file data or entries for directories themselves. If the entry is for a directory, the directory is recursed (S406), that is all files in the directory and any sub-directory are listed. Each directory entry only in snapshot 1 (S407) is schedule for unlink (and if a directory, recursed as an unlink path), S408. Each directory entry only in snapshot S2 (S409) will be scheduled for link (S410) (and if a directory will be recursed as a link path).

Data structures are produced as the snapshots are traversed, S412. The data structures include a directed graph of directory entries on which each has had zero or one operation scheduled. If an operation is scheduled it can be a “link” or “unlink” operation. Each directory entry may block another directory entry. Those directory entries that have scheduled operations are placed into a min heap. As is known in the art, a heap is a binary tree with a special ordering property and special structural properties. In a min heap the ordering property is that the value stored at any node must be less than or equal to the value stored in its sub trees. All depths but the deepest must be filled, and if not filled all values occur as far to the left as possible in the tree. The graph is built such that the min heap is always either empty or zero-weight-directory entry, no matter how many directories are added or removed. Circular dependencies are prevented by using a dynamically generated temporary location in snapshot S2 as a temporary storage location for directory entries on which operations might have yielded a circular dependency (unlinking mainly).

A finite state machine (M) is maintained for each seen inode, S414. Each time an item is seen during traversal, a state machine operation is invoked. Each invocation triggers a state transition to a new state and an action at the new state is performed. Actions include: scheduling an operation in the graph, generating a diff on an inode (immediately) and doing nothing (for example, a diff has already been sent and a file has been seen again in the same place, needing no action). Scheduling includes blocking operations on the parent directory entry.

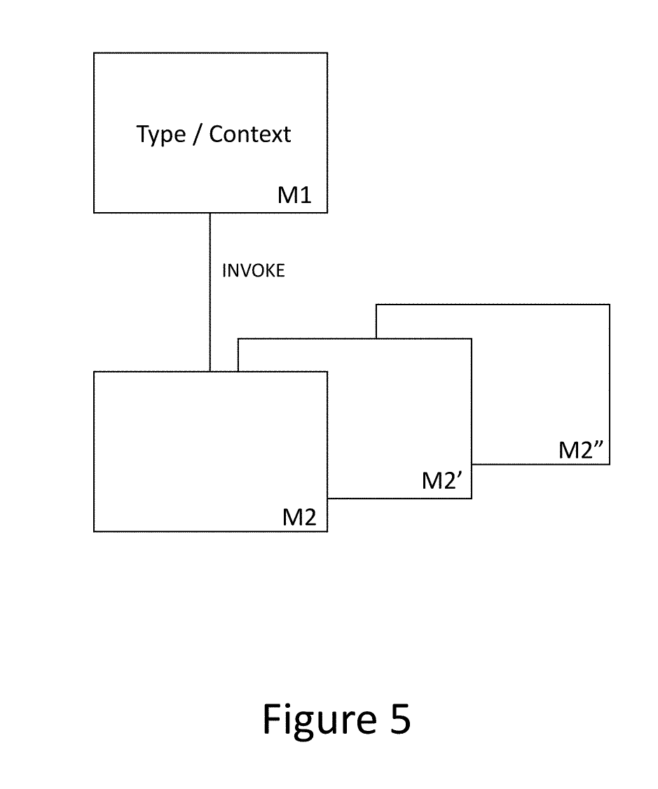

As shown schematically in FIG. 5, the state machine is implemented as a composition of two state machines: M1 and M2. M1 is a state machine that operates on the type and context. The context is any of “link”, “common” and “unlink” as shorthand for origin (source) only, both (source and target) and target only. M1 handles type changes and directory operations. M2 is state machine designed for the non-directory type and operates on context alone. M2 is invoked as an action from M1. There could be a number of different M2 state machines (M2, M2′, M2″) depending on the type. Implementing nested state machines avoids implementing one enormous state machine that encodes all types (e.g. regular, symlink, block device, character device, etc.). M1 is implemented in such a way that M2 can be a generic state machine. If a type is seen and no type has been seen yet for this inode, the M2 will be selected based on it. Then M2 will undergo a state transition. Initially, only M2 is designed as regular file state machine. Alternatively, other file types could be handled via checks in the actions for the file state machine, or by adding separate machines.

The callbacks that are done consist of:

*ResolveDiff (origin string, target string)
* origin is the path on the origin mount
* target is the path on the target mount
*
* This is for an inode. Both data and metadata are differenced.
*

*Create(path string)
*path in target containing regular file to be recreated.
*

*Link(path string, dst string)
* path is where we create the link
* dst is the link's target
*

*Symlink(path string)
* path is location in target of symlink to recreate.
*

*Unlink(path string)
* path is where the unlink command is executed
*

*Rmdir(path string)
* path is where the rmdir command is executed
*

*Mkdir(path string)
*path is location in target of directory to recreate.
*

*Mknod(path string)
*path is location in target of node to recreate.
*
* This is expected to handle block devices, character devices, fifos and unix domain
*sockets.

*MkTmpDir(path string)
* path to make directory with default permissions. It is to be empty at the end and also
* unlinked. The only valid operation involving this directory is Rename.
*

*Rename(src string, dst string)
* neither of these need correspond to things in the origin or target snapshots. It just
* needs to be sent to the other side to enable us to perform a POSIX conformant
* transformation of the hierarchy. This is used
* in conjunction with MkTmpDir.

These callbacks generate instructions to be transmitted in the messages to the receiver.

Once the traversal has finished, a next entry is popped from the heap, doing the operation listed via the implemented call back until all operations have been done.

The core of the delta algorithm is not concerned with the format of the API calls, nor how handling permission transformations may be done. The format of the calls may be handled by the code in the interface 14 which calls the algorithm. The permissions may be handled on the receive side. The immutable bit is an example of the latter.

CI Use Case

A particular use case with container image formats will now be described. According to currently available technology, there are restrictions on managing the life cycle of an application.

It is not possible to run multiple tests against the same data in parallel.

Loading data onto multiple machines to parallelise is costly.

When a test is over, the “golden” volume needs to be reset.

Debugging build failures is challenging.

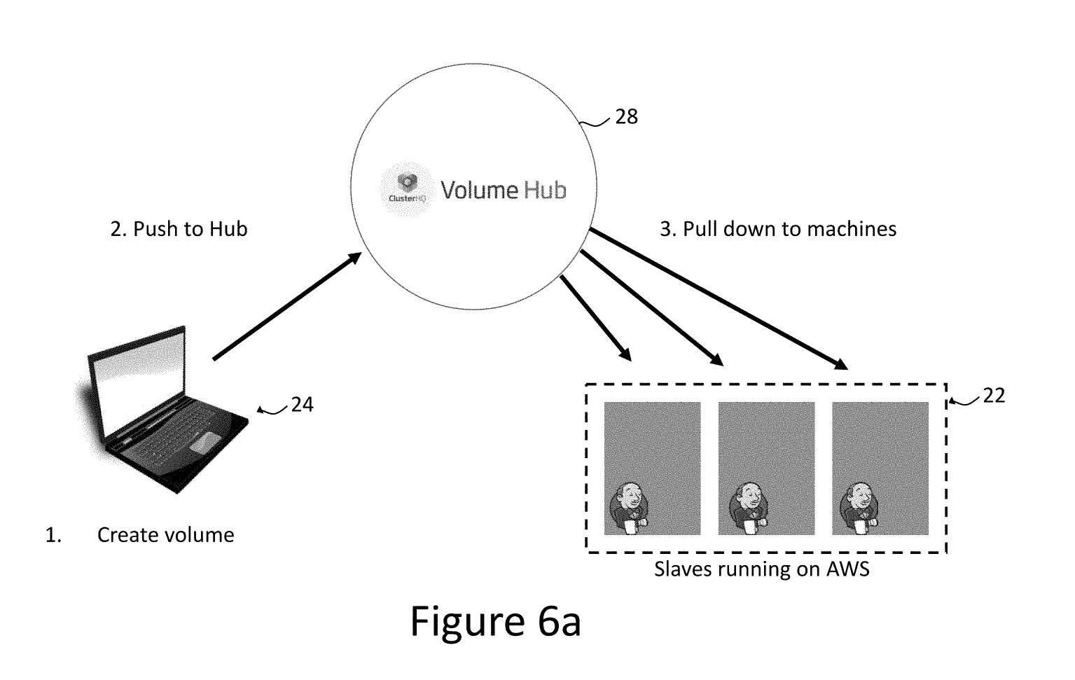

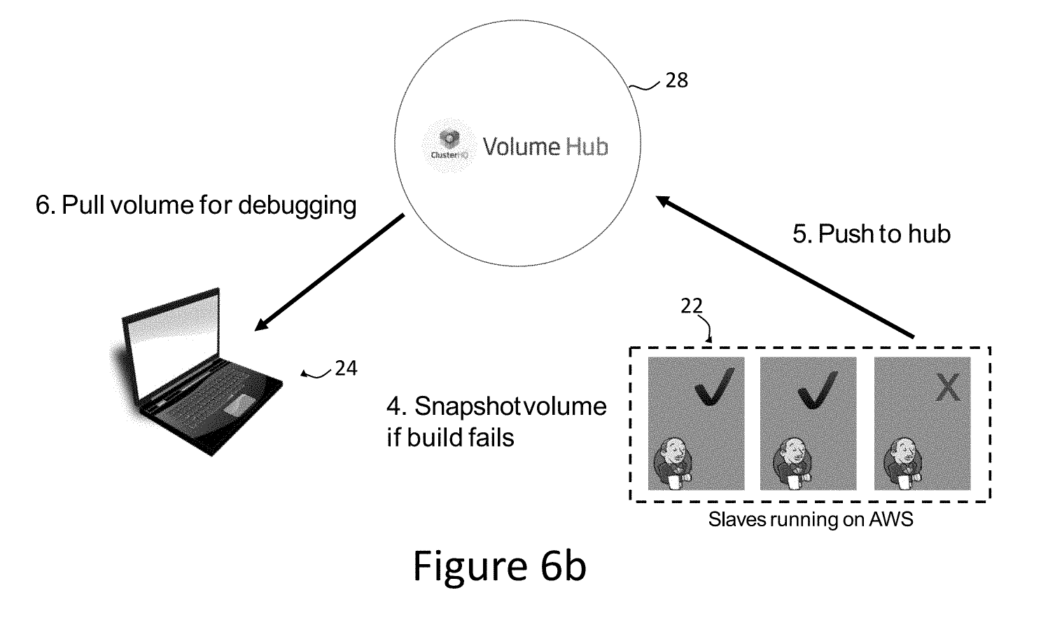

By using the volume hub which allows a shared repository of data stores with historical versioning and branching, these difficulties can be overcome. FIG. 6a is a schematic diagram illustrating a CI (container image) example using the volume hub. A volume (the “golden” volume) is created at step 1, for example in the development environment 24 and pushed to the volume hub 28. This volume can be pulled down to any machine, for example in the production environment 22. Note that each of the environments may contain many machines and these machines do not need to be running the same file system. Thus, the volume can be pulled to any machine, laptop, AWS, on-prem data centre.

Turning now to FIG. 6b, at step 4 the volume can be further snapshotted (for example, after build failure) and at step 5 pushed back to the volume hub. In FIG. 6b, the failed build snapshot volume is denoted by an X in the corner and it is this volume which is pushed back to the volume hub in step 5. When the test is over, the volume can be destroyed. The volume has been saved on the volume hub and can be pulled into the development environment for debugging as shown at step 6.

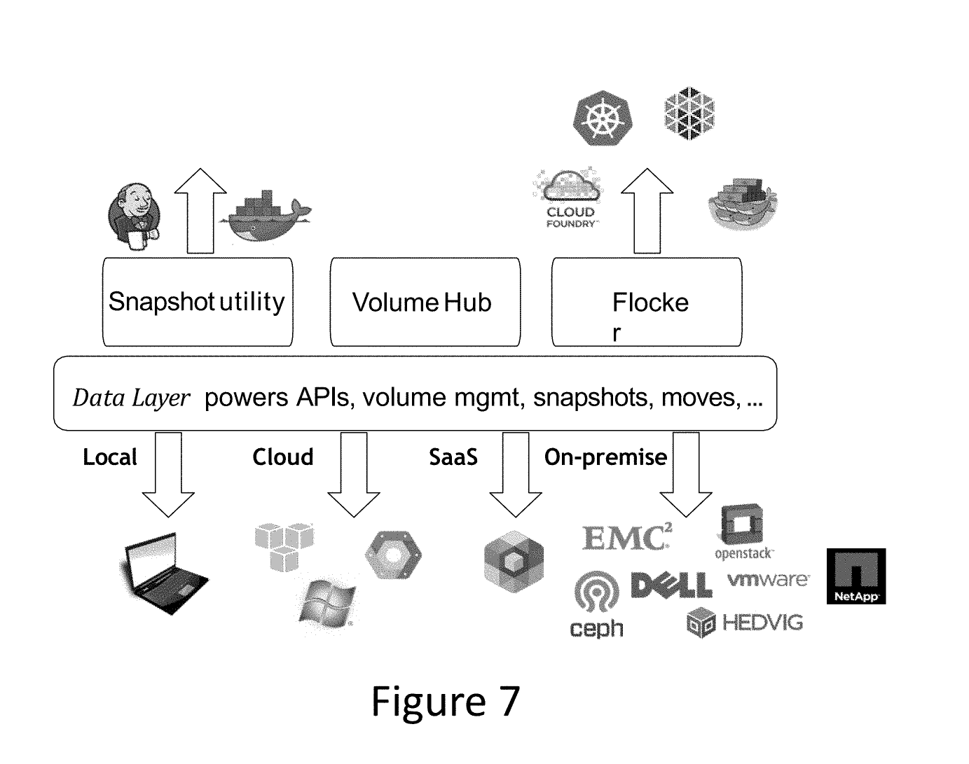

FIG. 7 is a schematic block diagram showing how the volume hub 28 can be used in a container data management architecture. Such an architecture has been further described in our patent application PCT/EP2015/078730 (WO 2016/087666), the contents of which are herein incorporated by reference.

### Some More Examples

Combining volume hub with CI formats such as Docker and Docker Registry gives the capability to capture and reproduce the full state of an application, consisting of the container images and data-volumes that they work upon. Let us call this stateful application image.

Here are a few use cases of such a system:

1. Developer Dave has written a web application to track customer orders which uses MySQL RDBMS for storing data. QA person Quattrone found a bug that only shows up with a particular set of customers and associated orders. Quattrone wants to capture the state of the full application, including the data, and reference that in his bug report. All the application code and startup scripts are packaged in a container image but the data files reside on an external data-volume. A tool to create stateful container image pushes the data-volume to Volume Hub, creates a manifest file with reference to container images and data-volumes and other relevant info. This manifest file is later used to recreate the full application, consisting of the container and the data-volume with a single that pulls the container image from its registry and data volume from volume hub. Furthermore, the application itself may consist of multiple containers and data-volumes. The manifest file itself is managed within the system and users can access the full application via a single URL. Multiple such application states can be captured for later restoration at a mouse click.

2. Student Stuart has worked on an assignment that operates on a publicly available scientific dataset and performs certain manipulations on that dataset. Stuart now creates a stateful application image and publishes the URL for his supervisor and teammates.

3. Salesman Sal creates a demo application with data specific to a prospective customer. San can create a stateful application image and use that for demo whenever needed.

How will this work?

Suppose we have an “Stateful Application Image Manifest” that looked like the following and was named stateful-app-manifest.yml.

docker_app:

docker-compose-appl.yml

volume_hub:

endpoint: http://<ip>:<port>

volumes:

redis-data:

snapshot: be4b53d2-a8cf-443f-a672-139b281acf8f

volumeset: e2799be7-cb75-4686-8707-e66083da3260

artifacts:

snapshot: 02d474fa-ab81-4bcb-8a61-a04214896b67

volumeset: e2799be7-cb75-4686-8707-e66083da3260

Where docker-compso e-appl.yml would be in the current directory and could be something like the below example except this file will not “Normally” work with docker because ‘redis-data’ and ‘artifacts’ volumes are not defined as they should be see https://docs.docker.com/compose/compose-file/version-2.

version: ‘2’
services:

web:

image: clusterhq/moby-counter

environment:
“USE_REDIS_HOST=redis”

links:
redis

ports:
“80:80”

volumes:
artifacts:/myapp/artifacts/redis:

image: redis:latest

volumes:
‘redis-data:/data’

What happens is the process replaces the ‘redis-data’ and ‘artifacts’ text within the file with the locations that dpcli pulls such as ‘/chq/4777afca-c0b8-42ea-9c2b-cf793c4e264b

When you would start the “stateful application image” you would run the following (pseudo) CLI command.

$ chq-cli [-v http://<ip>:<port>]-u wallneryan -t
cf4add5b3be133f51de4044b9affd79edeca51d3-f
stateful-app-manifest.yml -c “up -d”

What would happen is:

1. the program would look at the manifest and connect with the associated volume hub account
2. try to sync the volumeset
3. pull the snapshots
4. create volumes from those snapshots
5. then it would replace the volume name text with the volume mount directories
6. defer to docker-compose to run the app.

The final docker-compose-appl.yml would look like the following after we pull the voluminous snapshots and create them and replaced the text.

version: ‘2’
services:

web:

image: clusterhq/moby-counter

environment:
“USE_REDIS_HOST=redis”

links:
redis

ports:
“80:80”

volumes:

/chq/eb600339-e731-4dc8-a654-80c18b14a484:/myapp/artifacts/redis:

image: redis:latest

volumes:
‘/chq/4777afca-c0b8-42ea-9c2b-cf793c4e264b:/data’

Keep in mind, the user would only have to have dpcli, docker and docker-compose installed with a volume hub account. They would get the “stateful application image” manifest and perform a “run” command.

References to stored data in the context of this description imply data actually written on disks, that is persistent storage data on disks or other solid state memory. It is not intended to be a reference to capturing the state in volatile memory.

In another use case, Alice may be a developer who takes a snapshot of a production database. This snapshot is received by the volume manager and stored in the volume hub. Alice accesses it from the volume hub, fixes the bug and rewrites the fixed record in the database. She then pushes the new snapshot version back to the hub and advises Bob that he can now pull a new snapshot and run tests. In the hub, a temporal lineage is created representing the different states of the production database with time (FIG. 2a). Each snapshot is associated with metadata which indicates, for example, who generated the snapshot, from which IP address, for which project, at which time, etc. Snapshots may be caused to be generated triggered by humans or computers, responsive to any kind of triggering event. For example, triggering events could be time-based, event-based or sensor-based. An API exists which creates a snapshot and sends it from the volume manager to the hub when such a trigger is established.

When Alice pulls the original snapshot, it may be a very large amount of data (for example, a 100 Gigabytes). The change that she makes may be relatively small in order to fix the bug. She only writes back this change or “delta”. When Bob accesses the snapshot, he receives the original snapshot and the delta. The deltas are associated with identifiers which associate them with the base snapshot to which they should be applied.

There are different possible implementations. One may be a fully public hub. Another may provide a virtually privatised hub, and another may provide a hub which is wholly owned within proprietary data centres. Federated hubs are a set of associated hubs between which data (and snapshots) may be transferred.

In the delta algorithm described earlier, the delta is captured at the file system level in the form of system calls which would be needed to create the new version of the snapshot (which is the base snapshot after the delta is applied). There are existing techniques to produce deltas at the block level for disks, but no techniques are currently known to produce deltas in the context of file systems, particularly where file systems may be different at the sending and receiving ends. According to embodiments herein, the delta is captured at the level of the file name hierarchy.

When changes occur in a file, they could be from the creation of new files, the deletion of files, or files which have been moved around and renamed (and possibly modified). Where a new file is created, that new file is transmitted in the delta. Where a file is deleted, the delta takes the form of a system call to delete the file. Where a file has been moved around and renamed, the delta takes the form of a system call and also the changes which might have been made to the file when it was renamed.

As described above, the process (FIG. 4) of the delta algorithm involves the steps of computing the delta and then transmitting the delta in the form of instructions (system calls) derived from API callbacks. The snapshots which are created are immutable and this allows more than one person to branch off the same snapshot with their own identified deltas. The system calls may be in standard POSIX form.

This allows a shared repository of data stores with historical versioning and branching. The snapshots may be immutable, and can be associated with metadata. Metadata can also be associated with the deltas to tie the snapshots to the deltas for particular end cases. One snapshot may therefore branch off into two independent versions, where that snapshot is associated with two different deltas. This allows a collaboration of independent parties across a file state.

Delta Algorithm

A method, comprising one or more of:

identifying a first snapshot of the file system at the originator;

comparing, at the originator, the snapshot version of the file system to be replicated with the first snapshot to identify any differences; and

providing the differences in the form of a set of file system calls enabling the snapshot version to be derived from the first snapshot, whereby the snapshot version is replicated at the recipient based on the first snapshot and the file system calls without transmitting the snapshot version to the recipient.

The method can be related to replicating a snapshot version of a file system generated by an originator to a recipient.

Optional Features

Wherein two difficult snapshot versions are generated by two different originators based on comparison with the first snapshot.

Wherein the two different snapshot versions are replicated at two different recipients by providing two different sets of file system calls.

Wherein the first snapshot is stored as persistent data.

Wherein the file system calls are application independent.

Wherein the snapshot version is also stored as permitted data

Manually triggering the creation of a snapshot version

Automatically triggering the creation of a snapshot version by at least one of time-based, event-based or server-based triggers.

Use of Delta Algorithm for Debugging

A method, comprising one or more of:

accessing a first snapshot of a production database from a volume hub;

fixing at least one bug in the first snapshot in a development environment and transmitting a set of file system calls to the volume hub which, when executed on the first snapshot, generates a fixed snapshot version;

accessing the set of file system calls from the volume hub and generating the fixed snapshot version in a test environment by executing the file system calls on a copy of the first snapshot at the test environment.

The method can be related to debugging a file system.

Optional Features

The first snapshot is transmitted from the volume hub to the test environment with the file system calls.

(URL) Link to Stateful File

A system, comprising one or more of:

a registry holding at least one container image comprising application code and, optionally, start up scripts;

a volume hub holding at least one data volume external to the container image, the data comprising data files;

a computer-implemented tool operable to create a manifest file with reference to the at least one container image and the at least one data volume and to access the registry and the volume hub to retrieve the container image and the at least one data volume;

a user device providing to a user an interface with an accessible link whereby a user can cause the computer implemented tool to create the manifest file and deliver it to the user device.

The system can be related to providing stateful applications to a user device.

Optional Features: the link is a URL.

Volume Hub

A system, comprising one or more of:

a plurality of different run time environments including at least two of a production environment; a test environment; and a development environment;

a volume hub for holding snapshot data from the environments;

a production volume manager operable to produce data volumes in the production environment;

a data layer in the production environment operable to push snapshot data from the production volume manager into the volume hub; and

a data layer in the testing environment operable to pull snapshot data from the volume hub into the testing environment, whereby snapshots of data are exchanged between the environments.

The system may be a software development system, in which a software development cycle is executed.

Optional Features

wherein the volume hub stores multiple snapshots of a data volume, each snapshot associated with a point in time

each snapshot is associated with an originator of the snapshot

each snapshot is associated with an IP address of an originating computer device of the snapshot

the snapshot data represents a file system

the snapshot data is stored as non-volatile data

volume hub is public

volume hub is private

What is claimed:

1. A system, comprising:
one or more computer hosts each comprising one or more Central Processing Units, one or more file systems, a host operating system, and one or more memory locations;
wherein said Central Processing Units are operatively connected to said one or more memory locations and configured to execute one or more software on a host operating system;
wherein said software is configured to:
create one or more snapshots of said one or more file systems, identify one of said snapshots as an originator snapshot, identify a second snapshot, and determine differences between said second snapshot and said originator snapshot;
determine one or more file system calls transforming said originator snapshot into said second snapshot based on said differences between said second snapshot and said originator snapshot; and
store said one or more file system calls that transform said originator snapshot into said second snapshot in one or more of non-transitory storage and transitory storage.

2. The system according to claim 1, wherein said one or more file system calls are comprised of one or more of Portable Operating System Interface (POSIX) file calls.

3. The system according to claim 1, wherein said file one or more file systems is one or more of POSIX, ZFS, XFS, ext4, btrfs, LVM+, AWS, a journaling file system, or a logical volume manager (LVM).

4. The system according to claim 1, wherein said one or more file system calls are determined by a recurse of one or more directory structures contained in said originator and said second snapshots.

5. The system according to claim 1, wherein said one or more file system calls that transform said originator snapshot into said second snapshot is comprised of file system calls which would be needed to create said second snapshot from said originator snapshot.

6. The system according to claim 1, wherein said one or more file system calls that transform said originator snapshot into said second snapshot is configured to create, modify, delete or move one or more files and directories if said files and directories were created, modified, deleted, or moved respectively between when the originator snapshot and second snapshot were created.

7. The system according to claim 1, wherein said one or more file system calls that transform said originator snapshot into said second snapshot provide historical versioning.

8. The system according to claim 1, further configured to identify one or more snapshots as originator snapshots and configured to determine differences between said second snapshot and said one or more originator snapshots.

9. The system according to claim 1, further configured to identify one or more snapshots as originator snapshots and configured to determine differences between one or more second snapshot and said one or more originator snapshots.

10. The system according to claim 1, further comprising a sender host and one or more receiver hosts.

11. The system according to claim 10, wherein said originator snapshot is sent from said sender host to one or more second snapshots at said one or more receiver hosts.

12. The system according to claim 10, wherein said originator snapshot is replicated from said sender host to one or more second snapshots at said one or more receiver hosts.

13. The system according to claim 10, wherein said sender host and said one or more receiver hosts is either the same host computer or different host computers.

14. The system according to claim 10, wherein a plurality of said one or more snapshots are identified as originator snapshots.

15. The system according to claim 14, wherein said plurality of originator snapshots is sent from said sender host to one or more second snapshots at said one or more receiver hosts.

16. The system according to claim 14, wherein said plurality of originator snapshots is replicated from said sender host to one or more second snapshots at said one or more receiver hosts.

17. The system according to claim 14, wherein said plurality of originator snapshots is sent or replicated from said sender host to one or more second snapshots at said one or more receiver hosts; and each originator snapshot comprising said plurality of originator snapshots is sent or replicated to a different host of said one or receiver hosts.

18. The system according to claim 1, further comprising: one or more finite state machines, wherein said one or more finite state machines are configured to track changes in said one or more filesystems.

19. The system according to claim 18, wherein said one or more finite state machines are configured as one or more nested state machines.

20. The system according to claim 18, wherein a state transition in said one or more finite state machines corresponds to a file operation performed on said one or more file systems.
